(19) United States
(12) Patent Application Publication
(10) Pub. No.: US 2020/0368793 A1
(43) Pub. Date: Nov. 26, 2020

(54) ULTRASONIC LENS CLEANER STRUCTURE FOR A VEHICLE

(71) Applicant: Continental Automotive Systems, Inc., Auburn Hills, MI (US)

(72) Inventors: Jean-Christophe Deniau, Fenton, MI (US); Alia Jane Pierce, Auburn Hills, MI (US); Aruna Anand, Rochester, MI (US)

(73) Assignee: Continental Automotive Systems, Inc., Auburn Hills, MI (US)

(21) Appl. No.: 16/420,766

(22) Filed: May 23, 2019

(51) Int. Cl. B08B 7/02; G02B 27/00; B60S 1/56

(52) U.S. Cl. CPC B08B 7/028; B60S 1/56; G02B 27/0006

(57) ABSTRACT

An ultrasonic lens cleaner structure includes a lens of a device of a vehicle. The lens having an external surface disposed externally of the vehicle and exposed to environmental elements. An ultrasonic transducer is associated with the lens and is tuned to a resonance frequency of the lens. A frequency source is constructed and arranged to drive the ultrasonic transducer. When frequency generator drives the ultrasonic transducer at the tuned resonance frequency of the lens, the lens will vibrate at the tuned resonance frequency so as to remove or prevent the environmental elements from collecting on the external surface of the lens.

### FIELD

This invention relates to lenses of a vehicle that are exposed to the environmental elements and, more particularly, to an ultrasonic lens cleaner structure for cleaning such lenses.

### BACKGROUND

Vehicles typically include cameras, LIDAR sensors, and lighting, each having has a lens or transparent window cover disposed on the exterior of the vehicle and thus exposed environmental elements such as dirt, dust, water, ice, mud and other elements. Since the lens or window cover need to be clean for optimal operation, there is a need to provide an ultrasonic lens cleaner structure to clean the lens or window cover.

### SUMMARY

An object of the invention is to fulfill the need referred to above. In accordance with the principles of the present invention, this objective is achieved by an ultrasonic lens cleaner structure including a lens of a device of a vehicle. The lens having an external surface disposed externally of the vehicle and exposed to environmental elements. An ultrasonic transducer is associated with the lens and is tuned to a resonance frequency of the lens. A frequency source is constructed and arranged to drive the ultrasonic transducer. When the frequency generator drives the ultrasonic transducer at the tuned resonance frequency of the lens, the lens will vibrate at the tuned resonance frequency so as to remove or prevent the environmental elements from collecting on the external surface of the lens.

In accordance with another aspect of an embodiment, a method of cleaning a lens of a device of a vehicle provides the lens to have an external surface disposed externally of the vehicle and exposed to environmental elements. An ultrasonic transducer is associated with the lens. The method tunes the ultrasonic transducer to a resonance frequency of the lens. The ultrasonic transducer is driven at the tuned resonance frequency of the lens, thereby causing the lens to vibrate at the tuned resonance frequency to remove or prevent the environmental elements from collecting on the external surface of the lens.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic view of an ultrasonic lens cleaner structure for cleaning a lens in accordance with an embodiment.

FIG. 2 is a plan view of a vehicle employing the ultrasonic lens cleaner structure of an embodiment.

FIG. 3 is a flowchart of steps of a method of an embodiment.

### DETAILED DESCRIPTION OF EXEMPLARY EMBODIMENTS

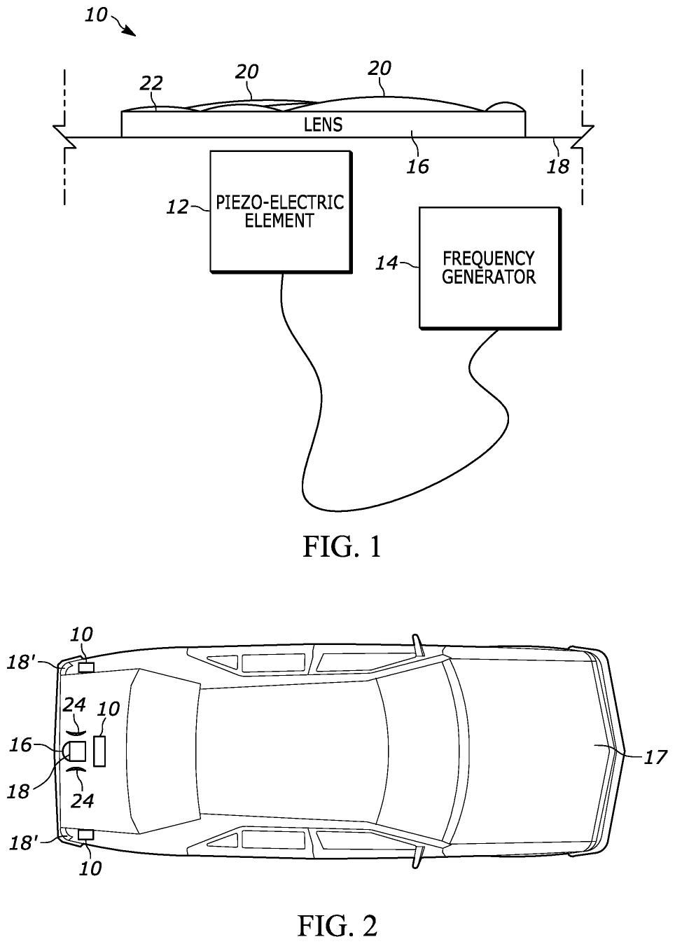

With reference to FIG. 1, an ultrasonic lens cleaner structure is shown, generally indicated at 10, in accordance with an embodiment. The ultrasonic lens cleaner structure 10 includes an ultrasonic transducer 12 and a frequency source 14, such as a frequency generator, electrically coupled with the transducer 12. In the embodiment, the transducer 12 is preferably a piezoelectric or a capacitive transducer that is constructed and arranged to be spaced from or be in contact with a lens 16 of a device of a vehicle 17 such as, for example, a camera 18, a LIDAR sensor 18′ (FIG. 2), a lighting element or other element having a lens and disposed external of the vehicle and exposed to the environmental elements 20 such as a dirt, dust, water, ice, mud or other elements that collect on an external surface 22 of the lens 16. In an embodiment, the lens 16 can be considered to be part of the ultrasonic lens cleaner structure 10.

As used herein, “lens” 16 can include any transparent window of the device 18, 18′ that needs to be clean for optimal functioning of the device. The lens 16 can be of glass, plastic, plexiglass or other materials that are conventional for a lens or transparent window.

The lens 16 has a known resonance frequency and can also have multiple known resonance frequencies depending on the material used and the shape/geometry of the lens 16. A resonance frequency is the frequency at which the lens will naturally resonate and thus will absorb the most energy from the frequency source 14. Thus, in accordance with the embodiment, to clean the lens 16, the frequency source or generator 14 drives the transducer 12 that is tuned to a resonance frequency of the lens 16. The energy created via the transducer 12 and generator 14 causes the exterior surface 22 of the lens 16 to vibrate at a resonance frequency thereof which causes environmental elements 20 to be removed or prevented from collecting on the exterior surface 22.

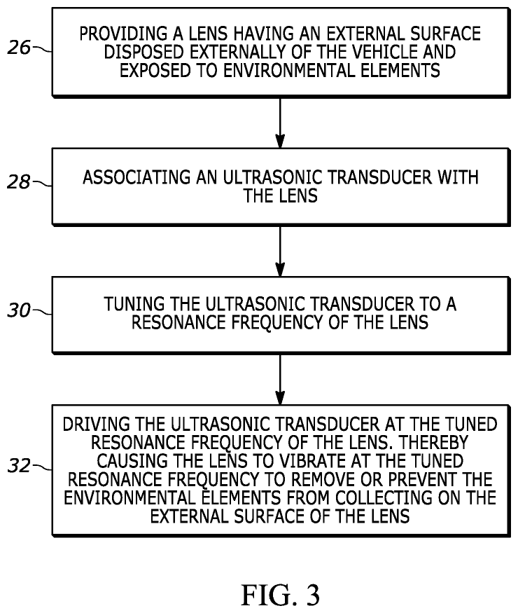

With reference FIG. 3, a method of an embodiment provides in step 26, a lens having an external surface disposed externally of the vehicle and exposed to environmental elements. In step 28, an ultrasonic transducer is associated with the lens. In step 30, ultrasonic transducer is tuned to a resonance frequency of the lens. In step 32, the ultrasonic transducer is driven at the tuned resonance frequency of the lens, thereby causing the lens to vibrate at the tuned resonance frequency to remove or prevent the environmental elements from collecting on the external surface of the lens.

The transducer 12 can be powered only when the vehicle 17 is operated or can be continuously operated if the current consumption of the transducer 12 is acceptable to the vehicle's battery lifetime.

Fundamental frequency and associated harmonics of the ultrasound wave from the transducer 12 can be considered in the design of the electronics for the device 18, 18′ employing the lens 16. When the device is a rear facing camera 18 or LIDAR sensor 19′, with reference to FIG. 2, the ultrasonic lens cleaner structure 10′ can further include at least one vortex generator 24 (vanes) disposed generally adjacent to the lens 16 of the device 18. The vortex generator(s) 24 disrupts the vortexes created by the pressure gradient in the rear of a moving vehicle for further cleaning of the lens 16.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. An ultrasonic lens cleaner structure comprising:
a lens of a device of a vehicle, the lens having an external surface disposed externally of the vehicle and exposed to environmental elements,
an ultrasonic transducer associated with the lens and tuned to a resonance frequency of the lens, and
a frequency source constructed and arranged to drive the ultrasonic transducer,
wherein when frequency generator drives the ultrasonic transducer at the tuned resonance frequency of the lens, the lens will vibrate at the tuned resonance frequency so as to remove or prevent the environmental elements from collecting on the external surface of the lens.

2. The ultrasonic lens cleaner structure of claim 1, wherein the ultrasonic transducer is a piezoelectric or a capacitive transducer.

3. The ultrasonic lens cleaner structure of claim 2, wherein the frequency source is a frequency generator.

4. The ultrasonic lens cleaner structure of claim 1, wherein the ultrasonic transducer is spaced from the lens.

5. The ultrasonic lens cleaner structure of claim 1, wherein the lens is transparent.

6. The ultrasonic lens cleaner structure of claim 5, wherein the lens comprises glass, plastic, or plexiglass.

7. The ultrasonic lens cleaner structure of claim 1, wherein the device is a camera.

8. The ultrasonic lens cleaner structure of claim 1, wherein the device is a LIDAR sensor.

9. The ultrasonic lens cleaner structure of claim 1, further comprising a vortex generator associated with the lens so that upon movement of the vehicle, the vortex generator disrupts the vortexes created by a pressure gradient of the moving vehicle to further clean the lens.

10. The ultrasonic lens cleaner structure of claim 9, wherein the vortex generator and the lens are disposed at a rear of the vehicle.

11. A method of cleaning a lens of a device of a vehicle, the method comprising:
providing the lens having an external surface disposed externally of the vehicle and exposed to environmental elements,
associating an ultrasonic transducer with the lens,
tuning the ultrasonic transducer to a resonance frequency of the lens, and
driving the ultrasonic transducer at the tuned resonance frequency of the lens, thereby causing the lens to vibrate at the tuned resonance frequency to remove or prevent the environmental elements from collecting on the external surface of the lens.

12. The method of claim 11, wherein the ultrasonic transducer is a piezoelectric or a capacitive transducer.

13. The method of claim 11, wherein the ultrasonic transducer is driven by a frequency generator.

14. The method of claim 11, wherein the ultrasonic transducer is associated with the lens by being spaced from the lens.

15. The method of claim 11, wherein the lens is transparent.

16. The method claim 15, wherein the lens comprises glass, plastic, or plexiglass.

17. The method of claim 11, wherein the lens is provided in a camera.

18. The method of claim 11, wherein the lens is provided in LIDAR sensor.

19. The method of claim 11, further comprising:
providing a vortex generator associated with the lens so that upon movement of the vehicle, the vortex generator disrupts vortexes created by a pressure gradient of the moving vehicle to further clean the lens.

20. The method of claim 19, wherein the vortex generator and the lens are disposed at a rear of the vehicle.
